(19) United States
(12) Patent Application Publication
(10) Pub. No.: US 2011/0174205 A1
(43) Pub. Date: Jul. 21, 2011

(54) SAIL AND METHOD OF MANUFACTURE THEREOF

(76) Inventor: Aaron Kiss, Fort Lauderdale, FL (US)

(21) Appl. No.: 12/970,457

(22) Filed: Dec. 16, 2010

Related U.S. Application Data
(63) Continuation-in-part of application No. 12/718,669, filed on Mar. 5, 2010.
(60) Provisional application No. 61/284,268, filed on Dec. 16, 2009.

(51) Int. Cl. B63H 9/06; G09F 7/00; G09F 21/18; B32B 37/02; B32B 37/10; B32B 37/06

(52) U.S. Cl. 114/102.29; 40/603; 156/285

(57) ABSTRACT

A sail includes at least two layers of durable sailcloth material, a scrim of load bearing yarns arranged in predetermined load path orientations, and at least one heat-activated adhesive layer securing the layers of material to the scrim, such that the scrim is positioned between the layers of material. An opaque layer may be included between the two outer layers of material to prevent the passage of light through the sail. Alternatively, the adhesive layer or layers may be dyed or otherwise colored to effectuate an opaque layer. The sail is preferably manufactured using a high temperature, vacuum lamination process to mitigate the quantity of voids between the layers of material and to transfer visible content from one or more image transfer mediums to the outside surface(s) of the layer(s) of material using dye sublimation to provide durable imaging. After lamination, the image transfer medium or media may be discarded.

### CROSS-REFERENCE TO RELATED APPLICATIONS

This application is a continuation-in-part of co-pending U.S. application Ser. No. 12/718,669, which was filed on Mar. 5, 2010, is entitled “Sail and Method of Manufacture Thereof,” claims priority upon U.S. Provisional Application No. 60/209,477 for commonly disclosed subject matter, and is incorporated herein by this reference as if fully set forth herein. The present application also claims priority under 35 U.S.C. §119(e)(1) upon U.S. Provisional Application No. 61/284,268 filed on Dec. 16, 2009 solely to the extent of the subject matter disclosed in said provisional application, which application is incorporated herein by this reference as if fully set forth herein.

### BACKGROUND OF THE INVENTION

1. Field of the Invention

This invention relates generally to aerodynamic lift devices and, more particularly, to sailboat sails adapted to bear digitally imaged informational content.

2. Description of the Background Art

Competitive sailboat racing enthusiasts consider the weight on sailboats very important, especially in the rigging and sails. At the same time, sailing has become commercialized with the addition of lucrative sponsorships. Combining the lightest sails with the sponsor's desire to have digital imaging capabilities has been impossible without adding a secondary process and materials to sail manufacturing. For example, traditional forms of secondary imaging on sailboat sails include adding dies, stickers, pressure sensitive adhesives, tapes and inks to provide limited image, logo or photo re-creation. However, such secondary processes and materials add undesired weight and additional layers to the sail, thereby negatively affecting the performance of the original product. Additionally, the use of such secondary processes often result in sails that display reversed images faded and backwards due to visible light penetration through the finished sailcloth, as well as limited photographic qualities. Thus, to date, advertising on racing sails has really been an afterthought.

Therefore, a need exists for a method of adding informational matter to a racing sail without altering the performance of the sail.

### SUMMARY OF THE INVENTION

It is, therefore, one object of the present invention to provide a quality competition sail adorned with high resolution and photorealistic informational matter without compromising performance ability of the racing sail, which may be a Dacron or Mylar-laminated sail. It is another object of the present invention to provide a method for fabricating a quality competition sail that includes and displays high resolution and photorealistic informational matter without compromising performance ability of the racing sail. It is a further object of the present invention to provide a sailboat that includes one or more quality competition sails adorned with high resolution and photorealistic informational matter.

These and other objects are accomplished through the manufacture and use of one or more sails, which have imaged thereon informational content, such as consumer advertising. Portions of the sail material are chosen by thickness and/or strength, and facilitate use of large printing apparatuses that can produce very large, photorealistic imagery, such as product photographs and logos. Alternatively, ink transfer sheets may by incorporated into the sail manufacturing process. Attempts to print, paint, stick or otherwise dispose such images upon sails having “draft” (i.e., sails which have more linear feet of sail material between the luff and the leech than the actual distance between the luff and the leech) have invariably resulted in distorted images as the draft of the sail opens up under wind loading. The present invention allows, in one embodiment, for imaged layers to be supplied in one consistent sheet or in pieces that can be placed together to form the desired airfoil shape on either flat paneled sails (e.g., utilizing tri-radial and or broadseaming techniques) or sails built upon variable three-dimensional molds. In another embodiment, ink transfer sheets may be used to dispose one or more desired images onto the top and bottom external layers or sheets of the sail during sail assembly, or may be used to sandwich an already assembled sail which may then be subsequently put though a pressure and heat treatment to image one or both sides of the sail at the same time.

Thus, the final image can be either pre-printed on clear, white or colored external layers or sheets (e.g., Mylar, Dacron, polyester, nylon, or other types of sailcloth) before the primary lamination process or included in the heat and pressure lamination of the layers of the sail, such as by adding ink transfer sheets at the bottom and top of the assembly originally prepared for lamination. Alternatively, the image can be added to the finally assembled sail's external layers or to one or both sides of a new or existing sail (e.g., Dacron, Mylar, polyester, nylon, or other types of sailcloth) to image on one or both sides at the same time.

Additional fittings in sail manufacturing, such as batten pockets and corner reinforcing patches, need special attention. In an attempt to leave the final image or images on the external layers of the sailcloth undisturbed, such fittings may be separately imaged and affixed to the final membrane with matching imaging in place so as to align with the sail imaging such that breaks in the overall image are not visible to the casual viewer. The proper imaging and installation of these final pieces is necessary to display a continual image, brand message or design.

When the external clear, white or colored sheets or layers of the sail material are laid flat upon a horizontal planar surface, they can be printed upon or dye sublimated, as so desired. Since some sails are larger than existing printers can accommodate due to the flattened nature of the material, plural sheets can be printed or otherwise imaged upon and combined, such as by stitching, pressurized heat seaming, taping or otherwise combining, along edges of the sheets so as to be used to form the entire sail. In use, a “draft” is created in the sail by aerodynamic forces causing the sail to assume an airfoil shape which drives the vessel through the water. Batten pockets or other fittings covered with artwork or other informational matter corresponding to those sections of the sail (where such fittings are desired) may be combined with the adorned, clear, white or colored outer sail layers, such as by stitching, heat seaming, taping or otherwise combining.

The use of materials chosen from the group of materials disclosed herein has exhibited the result of performance comparable to standard Dacron, Mylar™, Kevlar, etc. sails, but upon which can be printed, transferred or otherwise imparted detailed, photo-realistic images of products and/or other informational content which is visible on a sailing vessel.

There is also disclosed herein a novel method for manufacturing a high performance sail. In one embodiment, the method includes: (a) providing a first layer or sheet of clear, white or colored Mylar, Dacron, Taffeta, or other sail material imaged on one side with first informational, graphic and/or other visible content, (b) disposing a first heat-activatable adhesive layer to the other side of the first layer, (c) positioning the first layer on a sail support mechanism or table (e.g. horizontal surface or variable/adjustable three-dimensional mold) with the first adhesive layer facing upwards, (d) positioning a plurality of load bearing yarns upon the first adhesive layer in predetermined load path orientations, (e) providing a second layer or sheet of clear, white or colored Mylar, Dacron, Taffeta, or other sail material imaged on one side with second visible content, (f) disposing a second heat-activatable adhesive layer onto the other side of the second layer (f) positioning the second layer such the second adhesive layer faces the positioned load bearing yarns, wherein at least the first layer, the first adhesive layer, the plurality of load bearing yarns, the second layer and the second adhesive layer form a sail arrangement, (g) positioning the sail arrangement into a vacuum, and (h) applying appropriate heat and pressure to the sail arrangement while the sail arrangement is in the vacuum to activate at least the first and second adhesive layers and to mitigate a quantity of voids within the sail.

In an alternative embodiment in which the first and second external layers are clear, white, or lightly colored, a darker-colored (e.g., black or charcoal gray) or opaque layer or sheet may be added between the two external layers, if necessary, to substantially reduce the amount of light that can pass through the sail and thereby more effectively prevent the image on the first layer from being seen from the second layer, and vice versa. In such a case, the opaque layer or sheet would be positioned upon the load bearing yarns. Further, one or more additional layers of heat-activatable adhesive may be affixed or disposed upon one or both sides of the opaque layer to enable the opaque layer to attach to the two external layers and the load bearing yarns. The yarns can be comprised of Carbon Fiber, Spectra, Nylon, Kevlar, Mylar and other natural and polymeric fibers. In yet another embodiment in which the first and second external layers are clear, white, or lightly colored, the inside surface of one or both external layers may be printed, dyed (e.g., dye sublimated) or otherwise colored with a dark color (e.g., grey or black) to form one or more opaque layers instead of inserting a separate opaque sheet in between the load-bearing yarns and the second external layer. When included, the opaque layer may be sized to coincide with the sizes of the external layers or may be sized and arranged to reside behind the visible content on one or both external layers. In yet another embodiment, the opaque layer may be implemented by using a dark, tinted adhesive between the external layers and attaching the adhesive and the external layers in the same step.

The improvement in sail manufacturing provided by the present invention will enable sail manufacturers to supply their sailboat racing customers with a product with the same attributes as current racing technology but with a durable image that sponsors will be attracted to utilize in an effort to increase their exposure by displaying photogenic recreations of products, messages, or other visible content.

In one embodiment, the imaging of the clear, white or colored external layer(s) with the visible content may be performed at the time of sail lamination by adding ink transfer sheets to the assembly as the bottom and top layers. Such an imaging technique would allow the imaging process, which uses heat and pressure, to take place at the same time lamination of the sail layers takes place, thereby reducing the necessary steps involved in adding images to sails and making such imaging less complicated and less expensive. The physical imaging process onto the external sheet or sheets may alternatively be performed prior to assembly of the sail arrangement (which may be the entire sail or a portion thereof, such as when the sail is too large to print or otherwise image all at once), or after sail assembly should the external sheets or layers already be cut into the shape of a sail. Thereafter, printed batten pockets and reinforcement patches, grommets, reefing lines, etc. can be attached. In a further embodiment, this process of sandwiching a sail between transfer sheets can be utilized to image on one or both sides of a new or used Dacron or Taffeta sail.

In one embodiment, the sail manufacturing method of the present invention may be integrated into existing sail manufacturing methods, such as those described in U.S. Pat. Nos. 4,831,953, 4,624,205, and 4,593,639 with the specific changes discussed above and below.

### BRIEF DESCRIPTION OF THE DRAWINGS

The present invention can be best understood with reference to the accompanying drawings and from a consideration of the following detailed description in which corresponding parts are indicated by corresponding reference numerals.

FIG. 1 is a perspective view of an exemplary racing sailboat employing sails produced in accordance with one embodiment of the instant invention.

FIG. 2 is a perspective view of a sheet of white Mylar or similar material being imaged with visible content prior to sail assembly in accordance with one embodiment of the present invention.

FIG. 3 is an exploded, perspective view of various layers of a sail in accordance with one embodiment of the present invention.

FIG. 4 is a block diagram illustrating final stages of assembly of a sail in accordance with one embodiment of the present invention.

FIG. 5 is an exploded, perspective view of imaged fittings that strengthen the sail at high load areas and reef points and provide use of battens in “batten pockets” without altering the visible image, in accordance with one embodiment of the present invention.

FIG. 6 is a block diagram illustrating final stages of assembly of a sail in accordance with an alternative embodiment of the present invention using ink transfer sheets at the top and bottom of the sail assembly.

### DETAILED DESCRIPTION

The present invention is directed to a single layer Dacron or Taffeta, or multi-layer Mylar or other material, laminated sailboat sail providing high quality, durable imaging on both sides thereof, a sailboat that utilizes one or more such sails, and a method for manufacturing such a sail. In one embodiment, a high performance sailboat sail is constructed using Mylar laminated sail manufacturing processes that are altered by changing layer materials, and optionally at least a portion of the overall sailcloth arrangement, to allow for digital imaging without adding an external image layer, without increasing weight, without distorting shape, and while generally maintaining current industry manufacturing protocols. The sail is constructed by utilizing clear, white or colored Mylar, Dacron or similar film to allow for CMYK (cyan (C), magenta (M), yellow (Y) and black (K)) and RBG (red (R), blue (B) and green (G)) color separation techniques in digital imaging. The image may be applied to the film using large format printers or dye sublimation technology. An optional, but preferred, addition to the conventional sail lamination manufacturing process is the inclusion of an opaque layer (preferably 100% opaque), which may be a Mylar film, between the external film layers when such external layers are white or clear. The imaging may be affixed or applied to the external layers before, during or after lamination of the sails' layers creating a single membrane. In one embodiment, when the imaging is applied during lamination, ink transfer sheets may be introduced on the external surfaces of the external layers and laminated onto the external surfaces contemporaneously with the lamination of the sail layers.

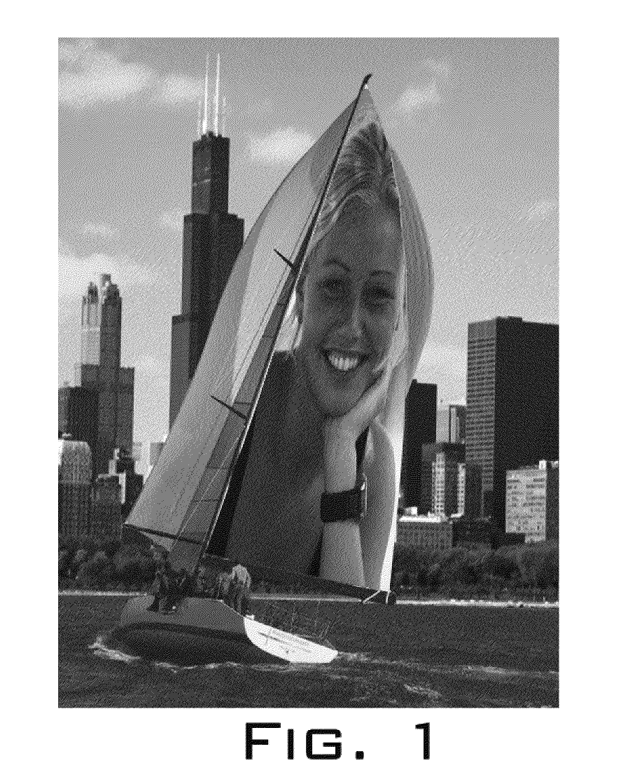

FIG. 1 depicts a racing sailboat 100 in accordance with one embodiment of the present invention. As depicted, the sailboat 100 includes a main sail 101 and a jib sail 102. In this embodiment, the main sail 101 is fabricated to include visible content (e.g., a photograph, a corporate logo, a slogan, an advertisement, or any other visually-recognizable content); whereas, the jib sail 102 is not. In an alternative embodiment, the jib sail 102 may also or alternatively include visible content and be fabricated as described herein.

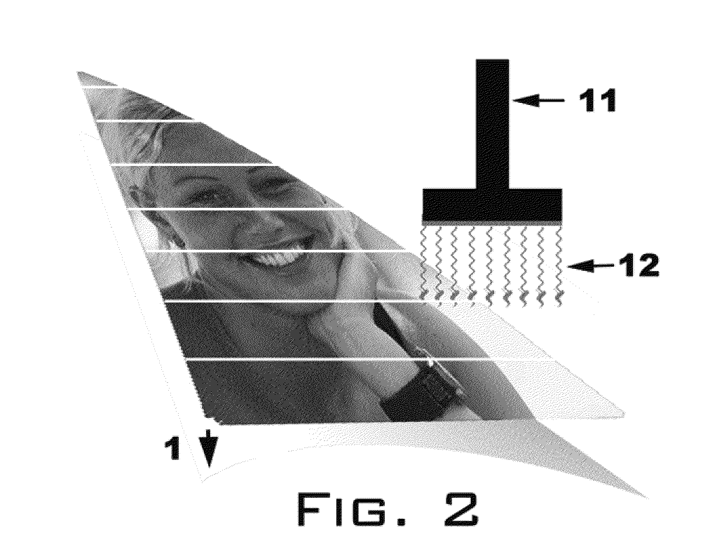

FIG. 2 is a perspective view of a sheet 200 of white Mylar or similar material being imaged with visible content 1 prior to sail assembly in accordance with one embodiment of the present invention. In particular, FIG. 2 illustrates direct or indirect digital imaging being affixed to or disposed on a sheet 200 of white Mylar or other durable white, clear, or colored sailcloth material capable of being used in a competitive racing environment. At least three different processes can be utilized to directly or indirectly affix the visible content 1 to the sheet 200. For example, two direct ways are soluble ink printing and UV cured ink applications. Soluble ink printing may be done by a 16½ foot wide Large Format Printer, such as the Vutek 5300 printer. The soluble ink is designed with chemicals that permeate the surface of the Mylar cloth to provide a durable image. However, soluble ink printing typically requires application of a liquid top coating of an ultraviolet (UV) ray inhibitor to protect the imaged content against fading when exposed for long durations to sunlight.

The second way to directly image onto a clear, white or colored Mylar sheet 200 is to use UV cured ink applications, such as provided by Hewlet Packard or Vutek large format printers. This allows for such applications to provide faster drying times, as well as durable imaging, and does not require the additional application of top-coating or UV inhibitors usually applied in the liquid form when using large format printers.

The final and preferred imaging process is an image affixation process and an indirect image application in the sense that it is a die process using dye sublimation. This process uses heat 12 and pressure 11 to both create microscopic bubbles or pores in the surface of the clear, white or colored Mylar sheet 200 and then transfer the inks from a solid state directly to a gas state and to fill the open pores with the exact color from a transferring medium that is first imaged upon backwards to end up with a correctly facing image 1 upon completion of the sublimation. The heat 12 is removed and the pores close trapping the gassed inks, which stick to the sides of each pore. This preferred process offers an extremely durable image that cannot be scraped off and can only be removed by destroying the integrity of the Mylar, Dacron, Taffeta, or other material sheet 200. Imaging using large format printers utilizing soluble inks, UV cured inks or dye sublimation transfer technology systems ensure a durable image.

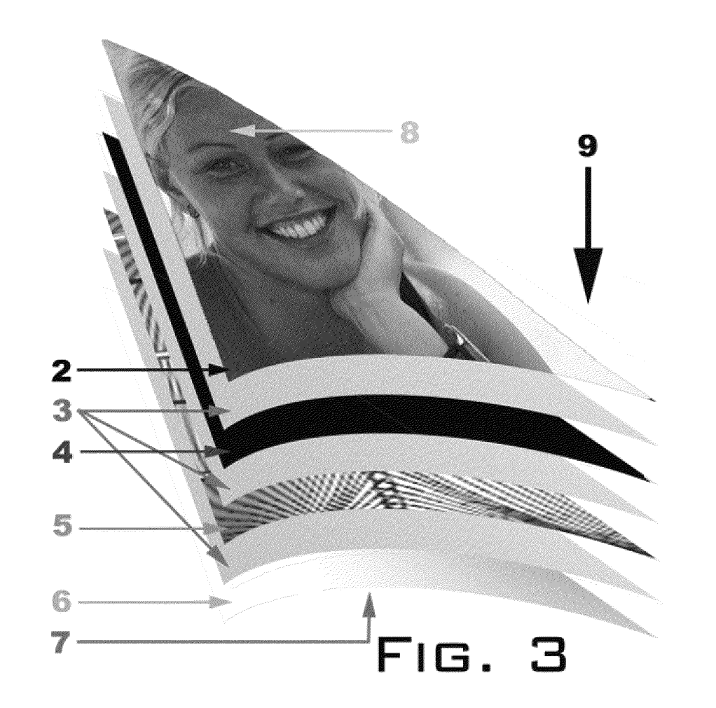

FIG. 3 is an exploded, perspective view of various layers of a sail 9 in accordance with one embodiment of the present invention. In particular, FIG. 3 shows the layers in an exemplary order of assembly including heat-activatable adhesive layers 3 positioned between each substantive layer 2, 4, 5, 6. The order of assembly of the layers 2, 4, 5, 6 may vary. In one embodiment, the sail 9 is assembled by first imaging visible content 8 on an outward-facing surface 7 of one (e.g., a bottom) clear, white or colored Mylar, Dacron or Taffeta layer 6 or sheet using, for example, the dye sublimation process disclosed above when visible content is desired for such surface 7. Next, the imaged Mylar, Dacron or Taffeta layer 6 or sheet is placed on a sail support mechanism or table, such as a flat-surfaced table or a sail table formed from an array of varying height jacks that form the layer 6 into an airfoil shape as is known in the art. An adhesive layer 3 of thermoplastic hot-melt adhesive is disposed on the inward-facing surface of layer 6 and a scrim layer 5 is positioned on the adhesive layer 3. The scrim layer 5 includes yams applied in a load bearing fashion arrangement, but the volume and orientation of the yarns may vary greatly across the area of the sail 9. For example, sections of the sail 9 expected to bear greater wind load may have a higher density of yams than other sections of the sail 9. Additional yams may be added in such high load sections and in order to address secondary loads while subjecting the sails to unpredictable wind forces.

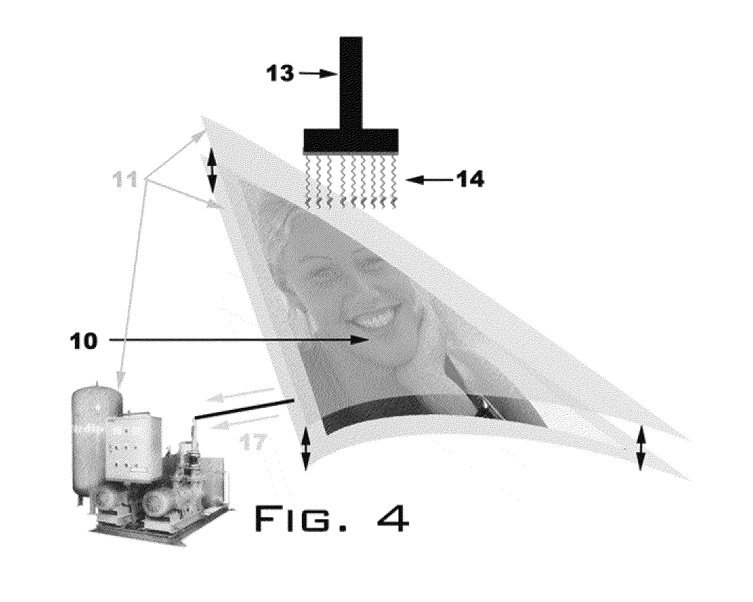

Another adhesive layer 3 is added or applied over the scrim layer 5. An optional opaque (preferably black or grey) layer 4 (e.g., Mylar), when included, is positioned on the scrim's adhesive layer 3 or, instead of applying an adhesive layer 3 over the scrim 5, such adhesive layer 3 may be more readily applied to the surface of the opaque layer 4 which will face the scrim layer 5. Alternatively, an opaque layer may be disposed on a rear or inward-facing surface of the top layer 2. Another adhesive layer 3 is either applied to the non-scrim side of the opaque layer 4 (when included) or to the inward-facing surface of the other (e.g., a top) clear, white or colored layer 2. Then, the top clear, white or colored layer 2 is positioned atop the opaque layer 4 or the scrim layer 5, as applicable, depending on whether a separate opaque layer 4 is included. When the other (top as shown in FIG. 3) layer 2 includes visible content 8, such content may be pre-applied to the outward-facing surface of the top layer 2 using dye sublimation or a direct imaging process as described above. After the sail's layers have been arranged as described above, the layers are attached to one another as detailed below with respect to FIG. 4.

In the foregoing embodiment, the sail 9 is configured with imaging on both outer surfaces of the final laminated sail membrane 9. In an alternative embodiment, the visible content may be imprinted on only one outer surface of assembled membrane 9. Alternatively, different visible content may be imaged on the two outer surfaces of the final sail membrane 9 or similar content may be contained on both other surfaces such that the content reads properly from both sides of the sail 9.

FIG. 4 is a block diagram illustrating final stages of assembly of a sail 9 in accordance with one embodiment of the present invention. In particular, FIG. 4 shows the steps in the process of laminating the layers 2-6 together in an attempt to make the final membrane 9 durable. In the illustrated system, a vacuum bag 11 is placed around the assembled layers 2-6 and attached to a vacuum pump 17. The vacuum pump 17 removes most all of the air within the bag 11 and the sail layers 2-6 and minimizes the voids. Heat 14 and pressure 13 are applied in combination with the vacuum to cause the adhesive layers 3 to activate and secure the Mylar, Dacron or Taffeta layers 2, 4, 6 and the scrim layer 5 together. Lamination occurs on a sail support mechanism or table, such as a flat surface or a three-dimensional mold. For example, some lamination processes may take place on a three-dimensional molded table prepared to mimic the final desired airfoil shape. Other lamination processes may take place on a flat surface and the resulting flat panels may be joined using known tri-radial, crosscut and/or broadseaming techniques.

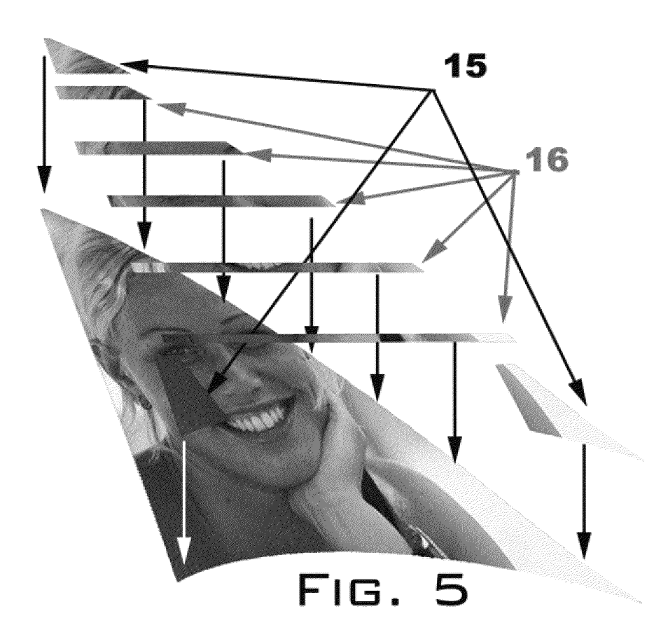

FIG. 5 is an exploded, perspective view of imaged fittings 15, 16 that strengthen the sail at high load areas and reef points and provide use of battens in “batten pockets” 16 without altering the visible image, in accordance with one embodiment of the present invention. In particular, FIG. 5 shows pre-imaged attachments 15, 16 that are sometimes necessary in sail manufacturing to prepare a sleeve 16 where any battens (sail support rods) need to be inserted and to provide reinforcement patches 15 in high load areas at the head, clew and tack of the sail and/or where reef points lay which are used to shorten the sail 9 or reduce sail area in high wind conditions. By preprinting these pieces and affixing them where they visually match, no noticeable interruption of the visible image or content occurs, thereby retaining a substantially continuous image on one or both sides of the laminated sail 9. In an alternative embodiment, the patches 15 may not be imaged and/or may be created with non-imaged cloth because the corners of a sail 9 are a very small percentage of the surface area of the entire sail 9 and, therefore, may not detract from an overall imaged design on the sail 9.

In addition, various fittings and other hardware (e.g., grommets, leach lines, batten cars, track cars, head boards, webbing, chafe protectors, etc.) may be affixed to or associated with the sail 9 as needed to attach the sail 9 to a sailboat 100 and make it completely functional.

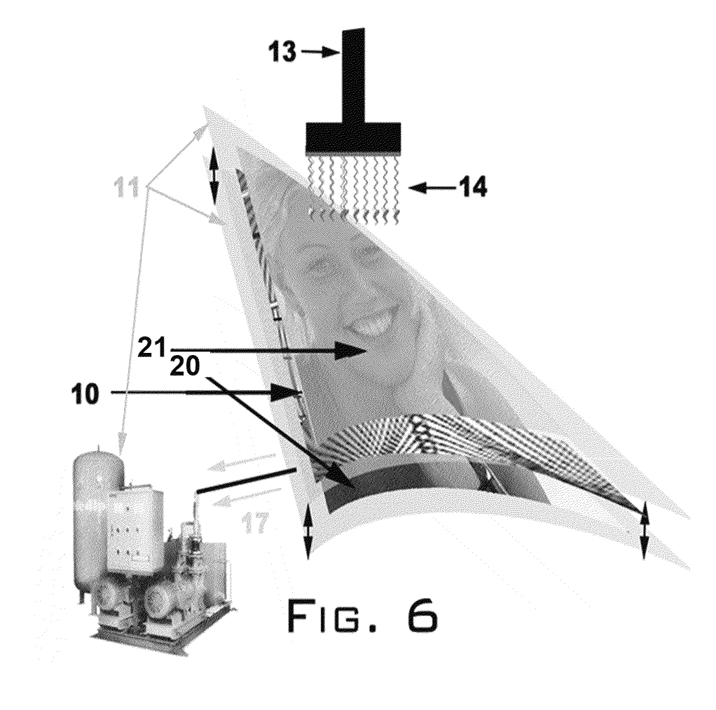

FIG. 6 a block diagram illustrating final stages of assembly of a sail 9 in accordance with another embodiment of the present invention. Thus, FIG. 6 is similar to FIG. 4 except that, in this embodiment, layers 2 and 6 are non-imaged. According to this embodiment, ink transfer sheets 20, 21 are placed on the bottom and top of the assembled layers 2-6 before vacuum bagging, heating and laminating. The ink images on the transfer sheets 20, 21 face inwards or toward the exterior surfaces of the top and bottom sail layers 2, 6. With such an arrangement, the ink images will transfer onto the exterior surfaces of the outer sail layers 2, 6 during sail lamination. Once lamination is complete and the sail is removed from the vacuum bag 11, the transfer sheets 20, 21 are pealed away from the exterior sail layers 2, 6 leaving the images on and imbedded into the sail's exterior layers 2, 6. A similar process can be utilized to image onto pre-fabricated (new or used) sails made of Mylar, Dacron, Taffeta or most any sailcloth. The ink transfer layers 20, 21 are designed to be used only once and discarded. The ink transfer sheets 20, 21 are similar to those typically used in other dye sublimation applications and are prepared on specialized printers such that the images to be impressed upon the sail's outer layers 2, 6 are backwards. As mentioned above, such a reversed image arrangement enables the images to be properly oriented for viewing once the ink is transferred from the transfer sheets 20, 21 onto the desired substrate (e.g., sail exterior layers 2, 6). Such an embodiment minimizes the number of alterations or changes required to be made to a laminated racing sail in order to provide imaging on the sail and simplifies the addition of imaging to the sail.

### EXAMPLE 1

A sail 9 in accordance with one embodiment of the instant invention is manufactured with two sheets 2, 6 of clear, white or colored Mylar film from Dupont Tiejin Films with imaging/visible content 1 pre-affixed. In the exemplary embodiment, the thickness of the Mylar for both the Mylar sheets 2, 6 and an optional black Mylar sheet 4 is approximately 0.05 mil to 0.75 mil in thickness (one mil=0.001 inches or about 0.02 millimeters). Alternatively, other thicknesses of the Mylar may be used as desired for the particular sailing application. The finished sail 9 includes at least two sheets 2, 6 of clear, white or colored Mylar film sandwiching a scrim 5 of yarns placed in a load bearing fashion commonly referred to as Load Path technology. The yarns used to form the scrim 5 may consist of different materials including, but not limited to, carbon fiber yarns, Kevlar yarns, Spectra yarns, nylon yarns, Vectran yarns, and other yarns commonly used in the manufacture of high performance sails. The bonding agent or adhesive layers 3 are a heat-activatable adhesive that is applied on to the sheets 2, 6 of Mylar or other material sheets used in sail assembly and is activated at time of lamination (e.g. as shown in FIG. 4) under either infra-red or conductive heat ranging from 200-400 degrees Fahrenheit with a minimum vacuum pressure of one atmosphere. An optional, but preferred, opaque light barrier sheet or layer 4 may be inserted between the scrim 5 and at least one of the sheets 2, 6 of Mylar to prevent light from passing through the sail 9. Other external pre-imaged pieces may be added as necessary by traditional means (e.g., as illustrated in FIG. 5) allowing the use of batten pockets 16, reinforcement patches 15 and other fittings as may be necessary to sail a boat in racing conditions.

The sail 9 includes visible content 1, 8 on the outer surface of one or both sides of the assembled sail membrane 9 as illustrated in FIGS. 1 and 3. The visible content may be textual informational matter, images, logos, slogans, photographs, any combination thereof, or any other visible content. The sail 9 is ideally suited for advertisement or sponsorship promotion when utilized on near-shore sailing vessels or racing sailboats with large media exposure. The final membrane 9 is preferably partially or fully opaque such that matter 8 printed on one side of the sail 9 will not show through to the other side when viewed in sunlight. Such opaqueness facilitates printing of independent matter on either side of the sail 9.

### EXAMPLE 2

A sail 9 in accordance with another embodiment of the instant invention is manufactured in a manner similar to the sail 9 of Example 1, except that the outer sail layers 2, 6 are not pre-imaged (i.e., do not have the image pre-affixed). In this case, ink transfer sheets 20, 21 having the desired content mirror-imaged thereon are placed upon the outer layers 2, 6 prior to lamination. Heat activation and pressure during lamination cause the images from the ink transfer sheets 20, 21 to transfer from the transfer sheets 20, 21 to the exterior surfaces of the outer sail layers 2, 6 to produce the images on the sail surfaces. After lamination, the transfer sheets 20, 21 are peeled away from the sail 9 and discarded. This same process can be applied to any sail material, whether it be Dacron, Mylar, Taffeta, Canvas, Polyester, or Cotton and whether it be new, used, completed or unassembled. This process may or may not make any portion of the sail opaque, although including some form of opaque layer (e.g., through use of an opaque adhesive as part of one or both ink transfer sheets 20, 21) would provide various benefits as detailed above.

As an example, but not by way of limitation, the above-described sail manufacturing process can be used for any sail on any vessel, including, but not limited to, main sails, jib sails, top sails, square sails, gaff rigged sails, roller furling sails, hanked on sails, racing sails, cruising sails and other sails.

This new technology allows for images on both sides to read in a properly oriented presentation or the imaging of two completely different images to be placed on either side of a sail without the worry of sunlight penetration mixing the two images on either side of the sail. Furthermore, the manufacturing process disclosed herein is integratable into current sail-making processes to provide photo-quality imaged sails at the same time as sail manufacturing, prior to sail manufacturing, or post sail manufacturing (e.g., after market).

This technology offers sponsors of sailing events and sailing crafts a more noticeable and recognizable reproduction of their message, slogan or branding message readable from longer distances. Furthermore, this method allows sponsors flexibility in the visual representation of their company's logos, brands image, or product representation. Additionally, steps are taken to supply secondary pieces, such as batten pockets and corner reinforcements, without compromising the integrity of the viewable content.

The instant invention has been disclosed above in exemplary embodiments to facilitate an understanding thereof. However, the invention is not restricted to the illustrative examples described above and illustrated in the drawings, but may be modified without departing from the intended scope of the invention.

What is claimed is:

1. A method for fabricating at least part of a sailboat sail, the method comprising:
providing an ink transfer medium that includes visible content on one side thereof;
providing a first layer of a durable sailcloth material having a first side and an opposing second side;
disposing a first heat-activatable adhesive layer onto the second side of the first layer of material;
positioning the ink transfer medium and the first layer of material onto a support structure such that the first adhesive layer faces upwards and the visible content contacts the first side of the first layer of material;
positioning a plurality of load bearing yarns upon the first adhesive layer in predetermined load path orientations;
providing a second layer of the durable sailcloth material having a first side and an opposing second side;
providing a second heat-activatable adhesive layer;
positioning the second layer of material upon the first layer of material such the second adhesive layer is positioned between the first side of the second layer of material and the plurality of load bearing yarns, wherein at least the ink transfer medium, the first layer of material, the first adhesive layer, the plurality of load bearing yarns, the second layer of material, and the second adhesive layer form a sail arrangement;
positioning the sail arrangement into a vacuum; and
applying sufficient heat and pressure to the sail arrangement while the sail arrangement is in the vacuum to transfer the visible content from the ink transfer medium onto the first side of the first layer of material, activate at least the first and second adhesive layers, and mitigate a quantity of voids between the first layer of material and the second layer of material.

2. The method of claim 1, further comprising:
positioning an opaque layer between the second adhesive layer and the first side of the second layer of material; and
providing a third heat-activatable adhesive layer between the opaque layer and the first side of the second layer of material,
wherein at least the ink transfer medium, the first layer of material, the first adhesive layer, the plurality of load bearing yarns, the second layer of material, the second adhesive layer, the opaque layer, and the third adhesive layer form the sail arrangement.

3. The method of claim 1, wherein providing a second heat-activatable adhesive layer comprises:
disposing the second adhesive layer on the first side of the second layer of material.

4. The method of claim 1, further comprising:
discarding the ink transfer medium after the sail arrangement is removed from the vacuum.

5. The method of claim 1, wherein the visible content on the ink transfer medium is reversed relative to an orientation of the visible content after the visible content is transferred onto the first side of the first layer of material.

6. The method of claim 1, wherein applying appropriate heat and pressure to the sail arrangement while the sail arrangement is in the vacuum results in dye sublimation of the visible content from the ink transfer medium onto the first side of the first layer of material.

7. The method of claim 1, further comprising:
prior to positioning the sail arrangement into the vacuum,
providing a second ink transfer medium that includes second visible content on one side thereof;
positioning the second ink transfer medium in contact with the second layer of material such that the second visible content contacts the second side of the second layer of material;
wherein at least the ink transfer medium, the first layer of material, the first adhesive layer, the plurality of load bearing yarns, the second layer of material, the second adhesive layer, and the second ink transfer medium form the sail arrangement, and
wherein the heat and pressure applied to the sail arrangement while the sail arrangement is in the vacuum are sufficient to transfer the visible content from the ink transfer medium onto the first side of the first layer of material, transfer the second visible content from the second ink transfer medium onto the second side of the second layer of material, activate at least the first and second adhesive layers, and mitigate a quantity of voids between the first layer of material and the second layer of material.

8. The method of claim 1, wherein the visible content includes at least one of textual informational matter, images, logos, slogans, and photographs.

9. A sailboat sail formed by a process comprising:
providing an ink transfer medium that includes visible content on one side thereof;
providing a first layer of a durable sailcloth material having a first side and an opposing second side;
disposing a first heat-activatable adhesive layer onto the second side of the first layer of material;
positioning the ink transfer medium and the first layer of material onto a support structure such that the first adhesive layer faces upwards and the visible content contacts the first side of the first layer of material;
positioning a plurality of load bearing yarns upon the first adhesive layer in predetermined load path orientations;
providing a second layer of the durable sailcloth material having a first side and an opposing second side;
providing a second heat-activatable adhesive layer;
positioning the second layer of material upon the first layer of material such the second adhesive layer is positioned between the first side of the second layer of material and the plurality of load bearing yarns, wherein at least the ink transfer medium, the first layer of material, the first adhesive layer, the plurality of load bearing yams, the second layer of material, and the second adhesive layer form a sail arrangement;
positioning the sail arrangement into a vacuum; and
applying sufficient heat and pressure to the sail arrangement while the sail arrangement is in the vacuum to transfer the visible content from the ink transfer medium onto the first side of the first layer of material, activate at least the first and second adhesive layers, and mitigate a quantity of voids between the first layer of material and the second layer of material.

10. The sail of claim 9, wherein the first and second layers of material are white sheets of Mylar.

11. The sail of claim 9, further including an opaque layer positioned between the second adhesive layer and the second side of the second layer of material.

12. The sail of claim 9, wherein at least one of the first adhesive layer and the second adhesive layer is opaque.

13. The sail of claim 9, wherein the ink transfer medium is an ink transfer sheet.

14. The sail of claim 9, wherein the visible content includes at least one of textual informational matter, images, logos, slogans, and photographs.

15. A sailboat sail formed by a process comprising:
providing a first ink transfer medium that includes first visible content on one side thereof;
providing a first layer of a durable sailcloth material having a first side and an opposing second side;
disposing a first heat-activatable adhesive layer onto the second side of the first layer of material;
positioning the first ink transfer medium and the first layer of material onto a support structure such that the first adhesive layer faces upwards and the first visible content contacts the first side of the first layer of material;
positioning a plurality of load bearing yams upon the first adhesive layer in predetermined load path orientations;
providing a second layer of the durable sailcloth material having a first side and an opposing second side;
providing a second heat-activatable adhesive layer;
providing a second ink transfer medium that includes second visible content on one side thereof;
positioning the second layer of material upon the first layer of material such the second adhesive layer is positioned between the first side of the second layer of material and the plurality of load bearing yarns;
positioning the second ink transfer medium onto the second layer of material such that the second visible content contacts the second side of the second layer of material, wherein at least the first ink transfer medium, the first layer of material, the first adhesive layer, the plurality of load bearing yams, the second layer of material, the second adhesive layer, and the second ink transfer medium form a sail arrangement;
positioning the sail arrangement into a vacuum;
applying sufficient heat and pressure to the sail arrangement while the sail arrangement is in the vacuum to transfer the first visible content from the first ink transfer medium onto the first side of the first layer of material, transfer the second visible content from the second ink transfer medium onto the second side of the second layer of material, activate at least the first and second adhesive layers, and mitigate a quantity of voids between the first layer of material and the second layer of material;
removing the sail arrangement from the vacuum after application of the heat and pressure; and
discarding the first and second ink transfer mediums after removal of the sail arrangement from the vacuum.

16. The sail of claim 15, further including an opaque layer positioned between the second adhesive layer and the second side of the second layer of material.

17. The sail of claim 15, wherein at least one of the first adhesive layer and the second adhesive layer is opaque.

18. The sail of claim 15, wherein the first ink transfer medium and the second ink transfer medium are ink transfer sheets.

19. The sail of claim 15, wherein the first and second layers of material are white sheets of Mylar.

20. The sail of claim 15, wherein the first visible content and the second visible content include at least one of textual informational matter, images, logos, slogans, and photographs.

21. A method for fabricating at least part of a sailboat sail so as to include visible content on at least one side thereof, the method comprising:
providing an ink transfer medium that includes the visible content on one side thereof;
providing a section of sailcloth having a first side and an opposing second side;
positioning the ink transfer medium against the sailcloth such that the visible content contacts the first side of the sailcloth; and
applying sufficient heat and pressure to the ink transfer medium and the sailcloth to transfer the visible content from the ink transfer medium onto the first side of the sailcloth.

22. The method of claim 21, further comprising:
providing a second ink transfer medium that includes second visible content on one side thereof; and
positioning the second ink transfer medium against the sailcloth such that the second visible content contacts the second side of the sailcloth;
wherein the step of applying sufficient heat and pressure includes:
applying sufficient heat and pressure to the ink transfer medium, the second ink transfer medium, and the sailcloth to transfer the visible content from the ink transfer medium onto the first side of the sailcloth and to transfer the second visible content from the second ink transfer medium onto the second side of the sailcloth.

23. The method of claim 21, wherein the step of applying sufficient heat and pressure comprises:
applying sufficient heat and pressure to the ink transfer medium and the sailcloth to dye-sublimate the visible content from the ink transfer medium onto the first side of the sailcloth.
